(19) United States
(12) Patent Application Publication
(10) Pub. No.: US 2023/0135254 A1
(43) Pub. Date: May 4, 2023

(54) A SYSTEM AND A METHOD FOR PERSONALIZED CONTENT PRESENTATION

(71) Applicant: Gennadii BAKHCHEVAN, Warszawa (PL)

(72) Inventor: Gennadii BAKHCHEVAN, Warszawa (PL)

(21) Appl. No.: 17/636,065

(22) PCT Filed: Jun. 28, 2021
(86) PCT No.: PCT/EP2021/067728

§ 371 Date: Feb. 17, 2022

(30) Foreign Application Priority Data
Jul. 1, 2020 (EP) 20183376.1

(51) Int. Cl. H04N 21/2668; H04N 21/235; H04N 21/81; H04N 21/234; H04N 21/442

(52) U.S. Cl. CPC H04N 21/2668; H04N 21/235; H04N 21/812; H04N 21/23424; H04N 21/44218

(57) ABSTRACT

A method for personalized content presentation to users includes presenting a first content item to a user, wherein the first content item has at least two distinct sections; receiving image data representative of the user watching the first content item while the first content item is being presented; determining a response of the user to each section of the first content item based on image data representative of the user and storing information on the distinct sections for which the user indicated a positive response as positively-responded sections; generating a second content item with a common section that is common to all of the users and a personalized section, wherein the personalized section is adapted based on the response of the user.

### TECHNICAL FIELD

The present invention relates to a system and method for personalized content presentation. In particular, the present invention relates to selection, creation and/or adoption of advertising (or content in general) materials based on users reactions (or responses in general) to a content material already presented to the user.

### BACKGROUND OF THE INVENTION

Nowadays marketing and information concerns every area of life, and the largest part of modern advertising is digital marketing/content delivery. Not looking for or considering technical progress, there are still unsolved problems, such as: advertising platforms, where advertising/content is shown, cannot provide a guarantee of a result, efficiency measure or even an indicator whether a presented advertisement has been watched by a human or not (due to these problems with known systems, a lot of content/information/adverting is simply skipped, ignored, or launched by a bot, which is a special program and/or any other system that repeats human behavior on the Internet).

Moreover, there is present an unidirectional communication of information i.e. from an advertiser to a user only, which limits an ability to provide advertisement/content that is in the interest of a particular person/user, meets users specific needs and preferences.

Further, it should not be forgotten, that a real person can provide wrong/false data/information and easily fool any searching and marketing algorithms, which are mainly based on gender, age, location and the like.

US2010328492A1 discloses a method for selecting and displaying images in accordance with attention responses of an image viewer. A gaze pattern analysis mechanism identifies a viewer response to a currently displayed image by analysis of the viewers emotional response as revealed by the viewers facial expression and other sensory inputs, and the selection of an image to be displayed is then modified in accordance with the indicated viewers attention response. The image to be subsequently displayed is selected from predefined images according to viewer response.

US2014317646A1 discloses generating linked advertisements that may include a preliminary advertisement and one or more subsequent advertisements, wherein the viewer is only shown the subsequent advertisement upon detecting a positive reaction to the preliminary advertisement. The subsequent advertisement is associated with presentation triggers that specify a context in which the subsequent advertisement should be presented. The subsequent advertisement is selected from predefined advertisements according to user reactions.

US2016307227A1 discloses a content publication device that includes motion/speed sensors to detect a position/speed of a passing observer in the vicinity and a content selector module selects targeted content for publication by the content publication device based on the detected position/speed of the passing observer. Upon detecting interest of the observer, more detailed content corresponding to the content of interest may be presented, selected from predefined content.

US2014003648A1 discloses a method for determining an interest level of a digital image to a particular person, wherein the digital image, or metadata associated with the digital image, is analyzed to designate one or more image elements in the digital image. Familiarity levels of the designated image elements to the particular person are determined. The image to be subsequently displayed is selected from predefined images that contain elements with high familiarity levels.

US2014278910A1 discloses a system configured to receive an advertisement, present the advertisement to a vehicle occupant and visually record an occupant response during the course of the advertisement presentation using a vehicle camera. The advertisement to be subsequently displayed is selected from predefined images according to user response.

### SUMMARY

The present disclosure is designed to solve at least one of the abovementioned drawbacks. In particular, there is a need for a technology which is capable of understanding or otherwise inferring a persons needs and provide/create content/information exactly for this person, which may be referred to as individual hypertargeting of advertisement(s)/content.

There is disclosed herein a method for personalized content presentation, the method comprising the steps of: presenting a first content item to a user wherein the content item has at least two distinct sections wherein each section has associated metadata identifying its properties; receiving image data representative of the user watching the first content item while the first content item is being presented; determining a response of the user to each section of the content item based on the user image data and storing information on sections for which the user indicated a positive response as positively-responded sections. The method further comprises: generating a second content item comprising a common section to all users and a personalized section wherein the personalized section is adapted based on the response of the user such that it includes content having metadata common with at least one positively-responded section; and outputting the generated second content item for presentation to the user.

In contrast to the prior art, wherein known systems were configured to select predefined (i.e. already generated and available for display) content items to be presented based on user profile, the present invention includes the step of generating a content item that includes a predefined common section and a personalized section that is adapted to the needs of that user and therefore generated on demand, depending on the current profile of the user. Therefore, in general, the main distinguishing feature over the prior art is generating on-demand content related to user response to previously viewed content. A technical effect of the present invention is that it generates, on demand in response to previously watched first content item, a new second content item that is adapted to the features of users interest detected when the user watched the first content item. This results in providing new content that is more likely to receive users attention than just the original, common section of the second content item, in view of the added personalized section that contains data for which user has previously shown a positive response.

The method may comprise generating the second content item after detecting that the user has consumed the first content item. This allows to attract more attention from the user to the watched content, because the user will be rewarded by receiving the second content item more closely matched to the interest detected during presentation of the first content. Moreover, if the content provider pays incentives to content creators, this allows to implement an incentive scheme where the creators will be renumerated only for content which was actually consumed by the viewers.

The personalized section may contain at least a part of multimedia data of the positively-responded section.

The personalized section may contain multimedia data generated by an artificial intelligence module based on metadata of the positively-responded section. In contrast to prior art systems, where the content to be presented was selected from predefined (pre-recorded) content items and therefore the variety of content was limited to the number of predefined content items, the present method allows to create new content items that are a mixture of existing content items and contain elements that are matched to the user positive reactions.

The method may further comprise adapting the audio or video parameters of at least part of the second content item based on metadata of the positively-responded section, wherein the audio or video parameters include at least one of: video brightness, video contrast, audio volume. This enhances the variety of content available to the users, as the existing content items can be adapted to the style preferences of a particular user.

The multimedia content can be modified by technologies known as “deep fake” engines, which allows to create new content which is perceived as natural to the users.

A response of a plurality of users may be detected based on the user image data. In that case, the personalized section can be adapted to preferences of the plurality of detected users. This allows to match the second content item more closely to the average interest of everyone watching the content (e.g. a family watching a TV set in a living room, or a crowd of people watching a billboard at a public place).

In case when the response of a plurality of users is detected, the personalized section can be adapted to preferences of the main user of the device presenting said content. This allows a main user to take main control over the displayed content, wherein the main user may be defined on demand, e.g. when a family watches a TV set and the current content is children programming, the family child may be set as the main user so that the second content is presented to the childs interest and not to the adults interests.

Determining a response of the user can be further based on output of at least one additional device comprising a sensor of physical and/or emotional and/or psychological condition of the user. This increases the efficiency of detecting the interest level.

Detecting whether the user has consumed the presented content item can be based on users gaze analysis. The presented content item can be considered as consumed if users gaze is detected as focused on the presented content item for a predefined threshold time. This is one of very efficient ways to effectively determine whether the user consumed the content.

In case a user fails to focus the users gaze on the content item, playback of the content item can be paused until users gaze is focused again on the content item. This allows to keep users attention on the content and make the user actively watch the full scope of the content.

The selection of the second content item can be adapted based on environmental conditions in which the second content item is to be presented. The environmental conditions can be detected using a microphone or geolocation. This allows to match the second content item not only to the current user interest, but adapt it to the context in which the content is watched.

The personalized section can be selected from a set of alternative content blocks. These may be predefined content items that are mixed into the predefined common section to dynamically, on-demand, create a new second content item personalized to the interests of the user.

There is also disclosed a computer program comprising program code means for performing all the steps of the computer-implemented method as described herein, when said program is run on a computer.

There is also disclosed a computer readable medium storing computer-executable instructions performing all the steps of the computer-implemented method as described herein when executed on a computer.

There is also disclosed a system for personalized content presentation, the system comprising a controller configured to execute the method as described herein.

### BRIEF DESCRIPTION OF THE DRAWINGS

These and other objects of the invention presented herein, are accomplished by providing a system and method for personalized content presentation. Further details and features of the present invention, its nature and various advantages will become more apparent from the following detailed description of the preferred embodiments shown in a drawing, in which:

FIG. 1 presents a diagram of the system according to the present invention;

FIG. 2A presents a diagram of the method according to the present invention;

FIG. 2B shows an embodiment, wherein the personalized section is generated such that it contains at least a part of multimedia data of the positively-responded section;

FIG. 2C shows another embodiment, wherein the personalized section may contain multimedia data generated by the multimedia generator;

FIG. 2D shows another embodiment, wherein the content item is adapted with respect to its audio or video parameters;

FIG. 3 presents a general overview of a users face map;

FIG. 4 shows a high level overview of a data structure comprising a user profile;

FIG. 5 shows an example of an advertisement susceptible to being tailored based on users profile; and

FIG. 6. Presents examples of users map modification.

### NOTATION AND NOMENCLATURE

Some portions of the detailed description which follows are presented in terms of data processing procedures, steps or other symbolic representations of operations on data bits that can be performed on computer memory. Therefore, a computer executes such logical steps thus requiring physical manipulations of physical quantities.

Usually these quantities take the form of electrical or magnetic signals capable of being stored, transferred, combined, compared, and otherwise manipulated in a computer system. For reasons of common usage, these signals are referred to as bits, packets, messages, values, elements, symbols, characters, terms, numbers, or the like.

Additionally, all of these and similar terms are to be associated with the appropriate physical quantities and are merely convenient labels applied to these quantities. Terms such as “processing” or “creating” or “transferring” or “executing” or “determining” or “detecting” or “obtaining” or “selecting” or “calculating” or “generating” or the like, refer to the action and processes of a computer system that manipulates and transforms data represented as physical (electronic) quantities within the computers registers and memories into other data similarly represented as physical quantities within the memories or registers or other such information storage.

A computer-readable (storage) medium, such as referred to herein, typically may be non-transitory and/or comprise a non-transitory device. In this context, a non-transitory storage medium may include a device that may be tangible, meaning that the device has a concrete physical form, although the device may change its physical state. Thus, for example, non-transitory refers to a device remaining tangible despite a change in state.

As utilized herein, the term “example” means serving as a non-limiting example, instance, or illustration. As utilized herein, the terms “for example” and “e.g.” introduce a list of one or more non-limiting examples, instances, or illustrations.

### DESCRIPTION OF EMBODIMENTS

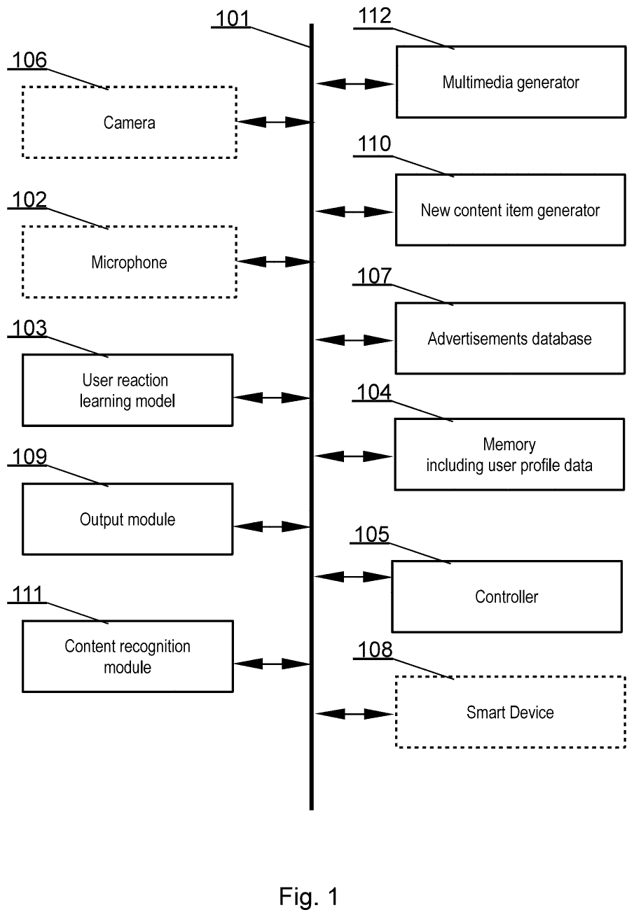

FIG. 1 presents a diagram of the system according to the present invention. The system may be realized using dedicated components or custom made FPGA (field-programmable gate array) or ASIC circuits. The system comprises a data bus 101 communicatively coupled to a memory 104. Additionally, other components of the system are communicatively coupled to the system bus 101 so that they may be managed by a controller 105.

The memory 104 may store computer program or programs executed by the controller 105 in order to execute steps of the method according to the present invention. In particular, the memory 104 may store user profile data.

The system comprises a user reaction learning model module 103, which is a module capable of machine learning based preferably on artificial intelligence (AI). Due to system complexity and multitasking, the present system is not tied to a specific type of Al and/or algorithms. It can operate based on machine learning, deep learning, neural networks, algorithms or any other type of artificial intelligence and/or algorithms that can process and analyze data according to needs of the system separately or jointly. Such a learning module may also be replaceable as a plug-in module allowing different vendors to provide such a module, be it hardware or software or a combination of hardware and software.

In an embodiment, there may be present more than one user reaction learning model modules 103 operating concurrently, wherein an output of a user reaction learning model module 103 having the highest probability of detection is selected for further processing. In another embodiment, such a user reaction learning model module 103 may comprise sub-models configured to partially execute the function of the user reaction learning model module 103, for example a first learning sub-model configured to detect and tract a users gaze while a second learning sub-model is configured to detect users skin tone changes.

A camera 106 may be a part of the system but alternatively the system may only be configured to receive user image data from an external camera representative of the user while watching content. The camera 106 may be any of a web camera, front-camera of any device (such as a tablet, notebook etc.), an external camera (such as a video surveillance camera) or any other cameras/devices configured to capture digital images of one or more person(s), who is/are (a) recipient object of an/a advertisement/content.

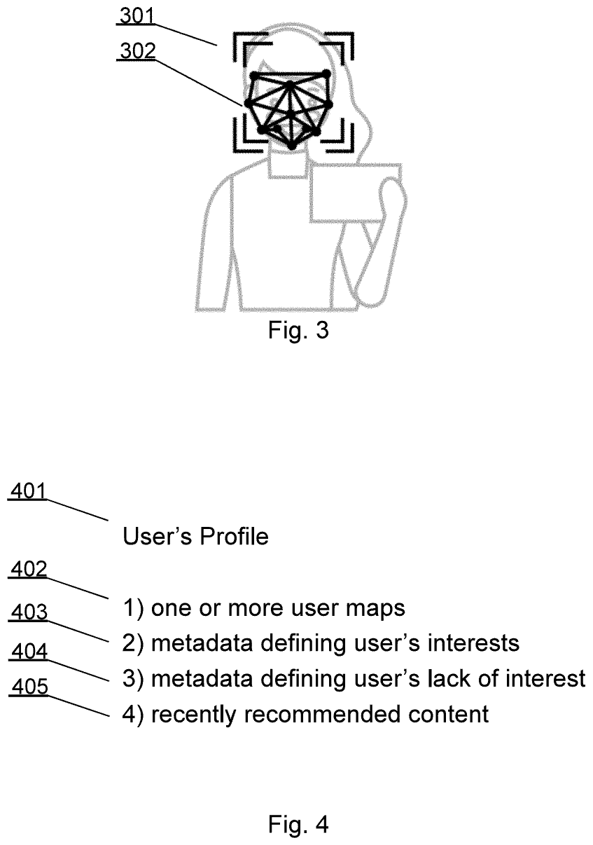

In a multi-user scenario the system may be configured to detect persons “maps” (description of maps is provided below, page 9, FIG. 3) (for example a family watching a series on a TV with a build-in or an external camera), and determine whether there have already been generated maps for the detected persons or not. There are several stages of behavior of the system (AI) in multi-user scenarios:

1) If previous users maps are not detected which may be associated with currently detected viewers, then a content is provided without personalization in order to subsequently detect triggers for the persons concerned. After at least one personal trigger has been detected, the system moves to the next stage;

2) If there is only one person detected and associated with a previously generated profile, then current content may be personalized according to that profile or not personalized at all, depending of options of content playback (it can be configured not to provide emotional triggers to other users). After detecting the profiles/maps and hence triggers of two or more users, the system moves to the next stage;

3) If there are detected two or more persons with a corresponding profile, then depending on content playback options:

a) The content may be adapted according to preferences (e.g. weighted) of both users (for example an advertisement may be selected to comprise a dog and a cat the same time, playing together if one user likes dogs and second user likes cats);

b) The system may play content for the main user of the corresponding device (that one which uses the device where advertising is shown the most, it can be smartphone, TV, digital billboard or/and any device where content/information/advertisement can be shown);

c) The system may find common triggers for the group of users/persons (such common triggers may be found based on the corresponding profiles of the persons). For example, all of them can be identified as interested in travel;

d) The system may also refrain from personalizing the content in order to avoid disclosure of personal triggers (e.g. triggers considered intimate by the system).

These content playback options can be changed according to privacy policy of the system or each user, e.g. via user settings, targeting options.

The system always tracks the quantity of users in such case and preferably makes changes in real time according to quantity of profiles detected and reacts on its change in accordance with the stages/steps described above. For example, while watching TV series system will analyze reactions of all users/persons and if one of them go out before content/advertising/information has started, the system will revise current state according to preferences of the remaining users/persons. If the user left while the content has been finished, the system can revise it according to preferences of the remaining users or keep it without changes till the end.

Also additional devices, built in features and/or optional equipment, which is able to receive and process additional data associated with a person, can be used for enhancement/confirmation of the results of user analysis. For example, a microphone(s) 102, built in device microphones or any other device configured to record sound, as well as smart devices 108 such as a smartwatch, having a function of heart rate measurement, smart glasses, smart contact lenses and/or any other devices or sensors which receive additional data about physical, emotional, psychological condition, during data analysis of a person(s), who is/are the recipient of advertising content. Such emotional condition is preferably one of: positive, happy, confused, neutral, negative, perplexed, unhappy, excited, angry, or sad, etc.

The system is also equipped with a local or remote advertisements (content) database 107, from which personalized advertisements may be retrieved for delivery to a user. The selected advertisements may be delivered (via a suitable communication link) to a target device or to a local output screen operating as an output module 109 for the system.

The advertisements (content) database 107 can be changed and adopted to certain user(s) profile(s) on the basis of user(s) preferences and reactions, as well as on the basis of content, which could be changed to fit those preferences, needs and interests of the user/users. The profile of the user can also be updated that may result in a need for changing the content of the database 107.

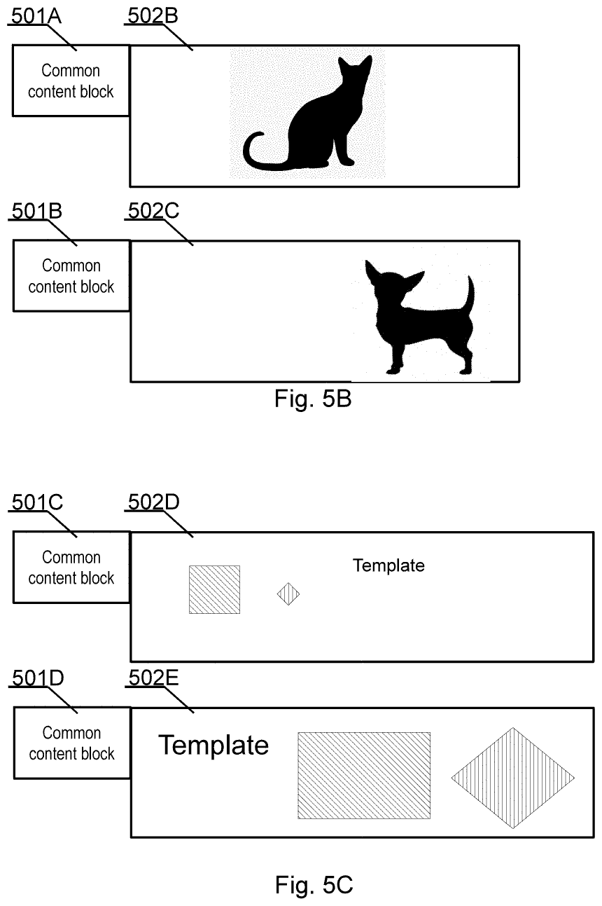

In general, the content stored in the database 107 may have a format as described with reference to FIG. 5. It is of particular importance that the content comprises a common section to all users and a personalized section.

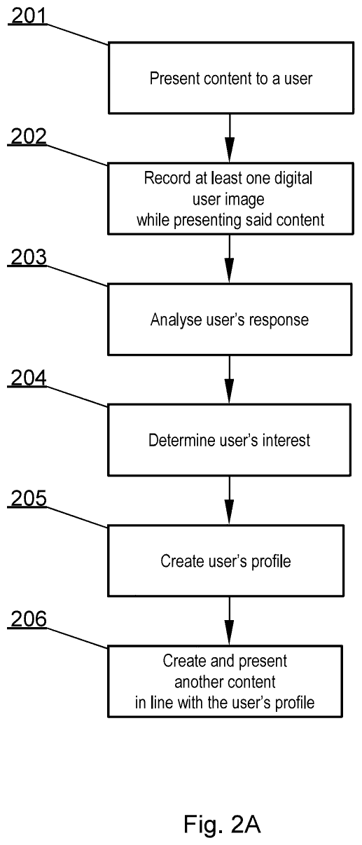

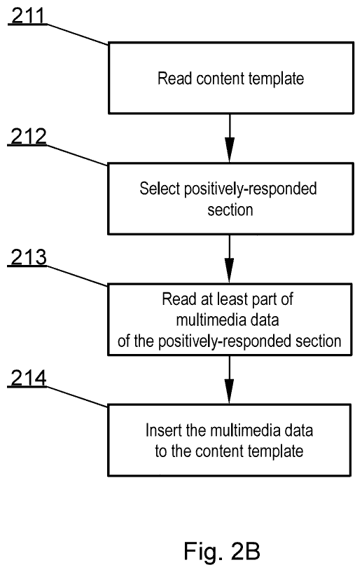

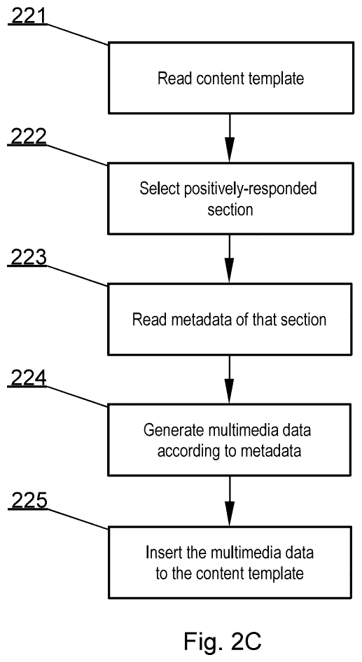

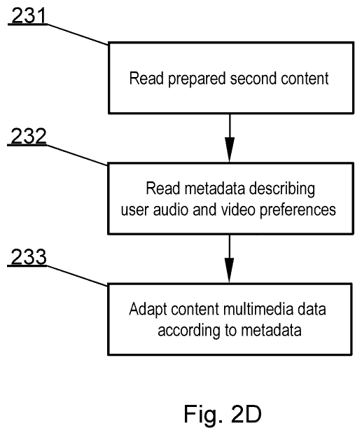

The second content item, including the personalized section, is generated by a new content item generator 110, such that the personalized section is adapted based on the response of the user such that it includes content having metadata common with at least one positively-responded section of the previously watched content. There are several ways by which this can be done, as described with reference to FIGS. 2B, 2C and 2D below.

A content recognition module 111 is configured to extract various features from the content being watched by the user (e.g. a cat or a dog, size, color, surrounding objects, brightness, contrast, audio volume).

A multimedia generator 112 is configured to generate multimedia data based on descriptive metadata. Various known technologies can be used to generate the multimedia data, including various artificial intelligence systems. In particular, the multimedia can be generated on the basis of multimedia templates adapted to specific features defined by metadata (such as a multimedia template corresponding to a running white cat that is modified by metadata defining that the cat shall be black). Such modification of the multimedia content can be performed by technologies known as “deep fake” engines, such as DeepFaceLab or Synthesia.

FIG. 2 presents a high level diagram of the method according to the present invention.

In the aforementioned system, based on at least one digital user image data 202 (and preferably based on a sequence of digital images data) there is analyzed user(s) reaction/response 203 to presented content 201 such as advertising content. The digital images are captured while the advertising content is presented to the user 202.

The reaction/response of the user may comprise information on whether a given user, present in the at least one digital image, has watched (consumed) the presented content. In particular, users gaze may be analyzed i.e. how much time a user has focused his sight/eyes on the presented content.

Users gaze information is received by the camera 106 or any other device/devices that can detect it, it is analyzed by Al/algorithms, that detects the users gaze directions, and whether the gaze is directed to a place where content/information/advertising is being shown (e.g. a devices screen). For example gaze detection methods of US2013054377A1 may be applied for this purpose as well as other methods available to a person skilled in the art.

In an embodiment, eye tracking, gaze directions tracking and other physical and other reactions are used to understand of users/persons processes to create a users profile, which is later used to obtain information about personal interest triggers.

Secondly, such users reaction/response may comprise determining how the user reacted to the advertisement e.g. was the user interested in the advertisement or not. An expressed interest of a user in a content item may also be quantitatively determined 204 based on a plurality of cues such as gaze, gestures, facial expression, heart rate (increase/decrease level) and the like, which may be given different weight factors influencing a final determination of users interest.

The interest of a user may also be determined based on distinct sections of each content item. For example, it may be defined that given object is presented in the content item in a first section and a different object is presented in a second section of the content item while it is determined that the user was more interested in the second section of the content item. Information on such section is stored in advertisements database 107 for the particular user profile, such as to store information on sections for which the user indicated a positive response as positively-responded sections, along with metadata of such sections. The metadata may be read from description of the content or may be automatically generated e.g. by content recognition module 111 that can extract various features from the content being watched (e.g. a cat or a dog, size, color, surrounding objects, brightness, contrast, audio volume). That information can be then stored in memory 104 as user profile data, that may include at least one of: overall information about the fields of interest of user (such as favorite items (e.g. cats or dogs), favorite colors, favorite surroundings, etc.) and particular sections of content that were of interest to the user (such as section identifier or even a copy of the multimedia data related to that content, and corresponding metadata describing that section).

Based on the analysis of users response, the system may determine users interest in similar content. Such similar content may be determined by comparing metadata associated with the presented content such as its topic, its associated product, its means of expression (e.g. indoor/outdoor images, images including celebrities or the like) or other properties related to the content.

A users profile may be generated 205, comprising captured images of a user as an identifier allowing future recognition of the user.

Lastly, based on the users profile, another content is presented 206 that matches (or at least is similar to the greatest extent currently possible) the users profile. Such presented content 206 may be created per user according to one of detailed procedures in FIG. 2B, 2C or 2D and as further explained in relation to FIG. 5.

FIG. 2B shows an embodiment, wherein the personalized section is generated such that it contains at least a part of multimedia data of the positively-responded section. First, a template of the content to be displayed (as explained on FIG. 5) is read in step 211. The template may have some metadata associated (such as e.g. a type of product that is advertised in that content).

Next, one of the positively-responded sections is selected in step 212. The selection may be based on a plurality of criteria, such as:
selecting positive response section that is considered of most interest to the user;
selecting the newest identified positive response section;
selecting the oldest identified positive response section that has not been recently presented to the user;
selecting the positive response section having metadata close to the template of the content to be generated.

In step 213, at least part of the multimedia data of the selected positively-responded section is read. For example, if an identifier of that section is stored in the user profile, the database of content (local or external) is searched for that multimedia data. Alternatively, that multimedia data may be stored along with the user profile in the memory 104. If only part of the multimedia data is read, this can be a portion of the section for which the user showed the most interest. Alternatively, the whole section can be read.

In step 214, the read multimedia data is inserted to the content template. Consequently, the second content item is generated based on the template and it includes a common section to all users and a personalized section that contains at least part of multimedia data to which user has previously responded positively. Therefore, when the user watches the second content item with the personalized section, it brings back positive memories to the user that watches again the same section that was liked by that user.

The use of sections from the content items may require permission of content copyrights owner and in that case for the system to be operable, suitable licensing agreements shall be arranged between the system operator and the content providers.

FIG. 2C shows another embodiment, wherein the personalized section may contain multimedia data generated by the multimedia generator 112 based on metadata of the positively-responded section. First, a template of the content to be displayed (as explained on FIG. 5) is read in step 221, similarly to step 211. Next, one of the positively-responded sections is selected in step 222, similarly to step 221. In step 223, metadata of the selected positively-responded section is read. The read metadata is then transferred to a multimedia generator 112 so that is generates multimedia data corresponding to the metadata in step 224. Then, in step 225 the generated multimedia data is inserted to the content template. Consequently, the second content item is generated based on the template and it includes a common section to all users and a personalized section that contains multimedia related to matters (defined by the metadata) that were previously positively responded by the user. Therefore, when the user watches the second content item with the personalized section, it brings back positive memories to the user that watches again a section of a type that is liked by that user.

FIG. 2D shows another embodiment, wherein the content item is adapted with respect to its audio or video parameters based on metadata of the positively-responded section, wherein the audio or video parameters include at least one of: video brightness, video contrast, audio volume. The modification is made by the multimedia generator. FIG. 2D starts as a continuation of FIGS. 2B and 2C, wherein the second content item is prepared with its personalized sections. The content item is read in step 221 and next the metadata describing user preferences is read in step 222 (e.g. the metadata may specify that the user likes bright images with quiet sound). In step 223 the content item is adapted based on the metadata (e.g. brightness is increased (in whole or in parts, e.g. in backgrounds) and sound level is decreased or one sound track is substituted with another one).

It will now be described how user image data registered by the camera 106 are processed. Any human face (FIG. 3 item 301) is unique, similarly to fingerprints, which are different for each person. When the camera 106 is connected to the present system, the system generates face “prints” or “maps” (FIG. 3 item 302). This may be based on determining feature points and image analysis resulting for example in defining a dots map, which is updated each time/image, because such a map can change, due to natural changes (growing, aging etc.), as well as due to unnatural reasons (tan, injuries etc.).

Such a Map may be generated using known techniques such as Face ID from Apple Inc., or similar techniques available to a person skilled in the art.

Unlike static map generation created for security purposes (i.e. user identification as such), the present mapping is also used for detecting differences in such maps according to a users reaction to a presented content.

These prints together with other data, which the Al and/or algorithms preferably obtain, such as gender, age, skin complexion (as it is preferably used to analyze physical reactions, such as a blush) are preferably transmitted and stored on remote servers and/or cloud services.

When a previously identified person (i.e. having an associated map) is subsequently detected (even by a different advertising terminal at another location), the persons map may be updated if needed i.e. an updated map is created. A content profile is associated with the map/print of a user, therefore even if such a person uses different content terminals (e.g. a smartphone, a table, a display at a shop, a TV screen), the profile will make the system present personalized content for this person.

When a person watches a content item, the person reacts to it, even if a reaction is such that the person does not pay attention to the content item. Human body has specific reactions on any information it receives, such as video, text or other type of advertisement/content or/and information. These reactions are tracked, scanned, processed, analyzed and attributed to a specific user, creating a profile of the persons interests, needs, preferences etc.

The present system determines those reactions, such as eye contact with the source of information (monitor, display, etc.), pupil resizing, smile presence, blush presence and/or any other human body reactions (gestures, eyebrows movement etc.), and processes the reactions/responses, in order to determine a level of engagement of the particular user with a specific topic, product, information, etc., defining emotional triggers of the given person.

Preferably, the present system is divided into two main parts (however the split may depend on different factors, such as devices processing power (whether the device is able to process all information locally, there can be present a form of a stand-alone system with external communication capability):

A First part (responsible for content outputting and receiving data from a camera) is an installed or a preinstalled part, which can for example be embedded in a website, application, program, device code or operational system. This part is responsible for data pre-processing process, which is an initial processing of images, videos, sounds and any other input information, received from their respective input data sources into data required by analytics systems that are for example Al/algorithms. The first part may also apply data privacy and security (e.g. encoding, encryption), to protect the data from unauthorized use;

A Second part (responsible for analytics) is a server/cloud part of the system, which processes data and provides results and recommendations based on the processed data, by determining which parts of content/information/advertisement were the most interesting to the user and whether the user paid attention to the content and provided any reactions to it. On this basis the system determines, in which information the person/user will be most interested. For example, which products are linked to the content presented. In other words, the aim is to determined emotion (or otherwise positive reaction) triggers for a given person. As a result, the first part of the system will receive another content item for presentation.

Content/information binding to users reactions can be done in both of those two parts, depending on specific needs, tasks, technical specification of devices. Thus, this aspect is implementation specific.

In one embodiment the determined information is not only used to select content of interest of a specific person but to tailor the content to the given person. This means not only to provide/advertise something that is potentially interesting, but also use audio/video triggers to advertise/provide other information. For example, if the present system detects that someone like cats, Al/algorithms/system does not only advertise food for cats, products for cats and etc. (because it is difficult to advertise the same range of products all the time, because it will cause negative reactions of the user, as well as advertisers would like to advertise other products), but uses/inserts video/image/sound related to cats in other advertisement of a product during an advertising campaign e.g. an advertisement of a frying pan, will be modified by the system such that video images will be inserted in which a cat is happily walking around it while a person is cooking. Another person who prefers dogs to cats will see the same advertisement modified such that the section comprising a cat will be exchanged with an audio/video section in which a dog is present instead.

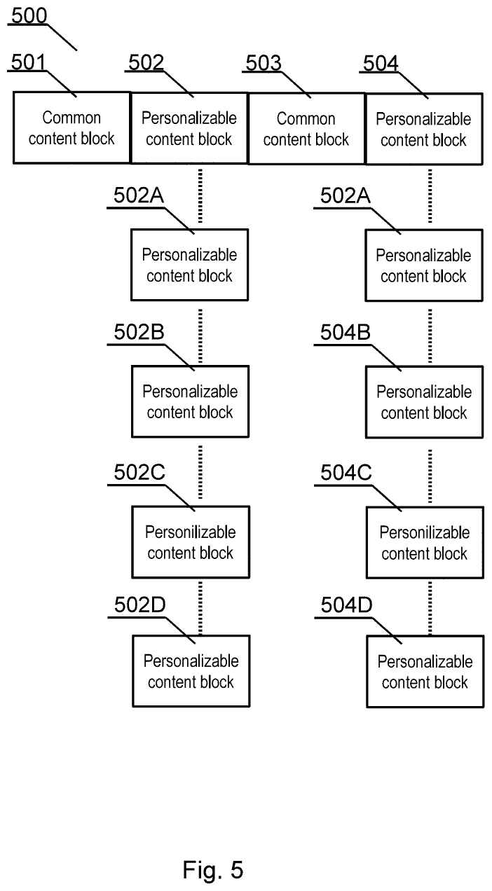

FIG. 4 presents a high level overview of a data structure comprising a user profile. A Users Profile 401 comprises one or more user maps 402 which are associated with a given user and allow identification of a face of the user. More than one map may allow for identification when an identification based on one map does not provide sufficient certainty of identification.

Further, the users profile 401 comprises metadata defining users interests 403. Such metadata may be identifiers of different content categories or different objects the user is particularly interested in.

Optionally, the users profile 401 may comprise metadata defining users dislikes 404. Such metadata may be identifiers of different content categories or different objects the user is particularly uninterested in. Having such metadata is beneficial as having only 403 metadata considers all other content as uninteresting, while it may not be the case.

Lastly, the users profile 401 may optionally comprise a list of recently shown content items 405 so that it may be avoided that the user is very frequently shown the same content.

FIG. 5 shows an example of an advertisement susceptible to being tailored based on users profile. An advertisement 500 of FIG. 5 has four sections 501 to 504. Two of these sections, namely 501 and 503 are sections common to all presentations of this advertisement/content. However, sections 502 and 504 may selectively be tailored depending on characteristics of a target user. To this end, the section 502 (may be considered a default section) may be presented as one of options 502, 502A to 502D while the section 504 may be presented as one of options selected from 504, 504A to 504D.

In other words, the content comprises more than one section wherein at least one of such sections and fewer than all sections are exchangeable based on the users profile.

An analysis of user engagement is effected by the user reaction learning model module 103 and preferably processed by an Al, which is taught to obtain and determine responses (reactions) of a user to a presented content/information/advertisement. As mentioned earlier, the system creates a “map” or “print” using any sources of observation and any change of this map (while interacting with the presented content) is analyzed.

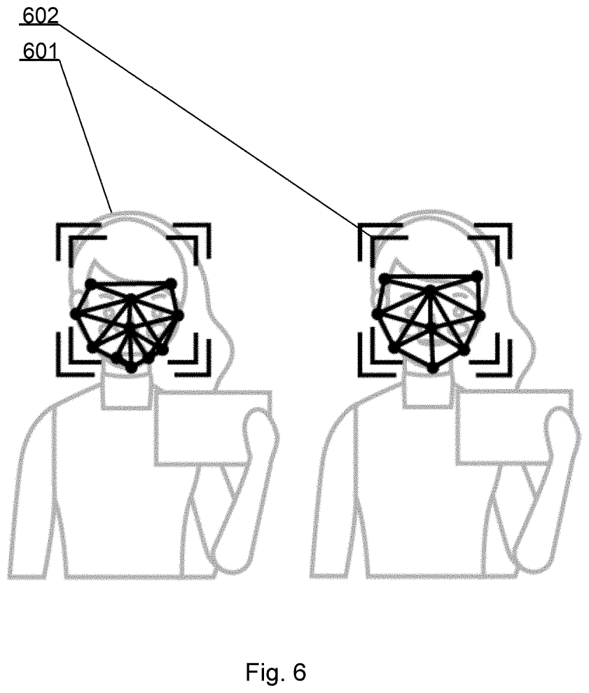

As an example, FIG. 6 presents how a map/print changes in response to information/content/advertisement. A simple example, is when a given person is happy or in a good mood/i.e. a positive reaction is inferred from a smile 601. The smile causes a change of the map/print by moving points/dots assigned to the corners of the lips which are moving up in the corresponding image, and the system recognizes such a case based on its taught rules. An opposite reaction is sadness, when the corners of the lips move down 602 in the corresponding image.

The system may store the most recent map or more than one preceding maps in the users profile 401.

As a skilled person will recognize there are many more types of reactions to content, and thus methods to detect them. Examples of further reactions are eye contact, time of eye contact, change of eye pupil size, skin tone change, facial muscle changes, as well as micro-reaction changes, brow raise etc. Al is based on a special coding system, which describes human facial movements, and other uncontrolled, as well as controlled reactions of the body (such as involuntary exhalation, exclamation, blood pressure changes, pulse changes etc.).

In addition the system associates sections of presented content and its metadata so that an association is made between the content type and the particular reaction of the user. The system is configured to categorize users expressions of emotions and/or reactions, systemize then and analyze. After that, based on the results, the system (AI) may formulate a users profile 401.

When a users profile 401 is determined, two main options of behavior of the system include (a) Provide to the user information/content which is most relevant (superficial level of use); and (B) Use that relevant information together with any other information/content (for example advertising of something) to create positive and/or attractive image of content for the person/user (deep level of use). As described earlier with reference to FIG. 5 in the example of inserting cat audio/video into advertising of a frying pan, if the particular user like cats.

The aforementioned deep level of use may be divided depending on difficulty of its associated tasks, for example:

Insertion of pre-defined trigger templates of interest (this may be defined for most common topics of interest such as travel (divided into categories e.g.: sea, mountains etc.), food, animals and so on). Such group of trigger templates may be changed over time depending on both external and internal factors, on the basis of the results of analysis (for example hunger, i.e. a person would be more interested in food, or is a person/user staying long at work or at home, hence the person would be more interested in travel);

Creation of a personal, emotional trigger which is more personal and sometimes can even have no clear boundaries (for example a given user may prefer lighter or darker background, a user may prefer faster or slower information adoption, which means faster or slower content provision). Also it means provision of emotional triggers, which are not pre-defined as templates, if they are not so common, and need more personalization (for example not just home animals are considered, but a specific type of animal and its breed which can vary greatly). For this purpose, the Al (system, algorithms) creates a new trigger, which is attributed to a certain person/user.

In other words, the content of the advertisement may stay the same or almost the same while based on the users profile the method of presentation will be adapted e.g. slower version, louder version, different language version, a version having for example larger objects presented in the displayed images (e.g. for a person expressing poor sight).

Examples of such tailored content items have been shown in FIGS. 5B and 5C where a common content section 501A-D is shown to all users while a tailored section 502B-E is shown to specific users wherein the personalized content is completely different as in FIG. 5B or the personalized content comprises the same objects but presented in a different manner as shown in FIG. 5C. The system may monitor the user preferences and if it becomes evident that a large group of people share some interest (e.g. images of white cats), the tailored sections 502B-E may be provided such that they correspond to most popular user preferences.

In some cases, it is beneficial to restrict content to certain users even if they might react positively to it. This may be linked to age restrictions, illegal interests and similar. Since the present system may detect for example age based on the image of a person, such detection is reliable.

A further beneficial effect of the present invention is that a user is actually recognized and associated with certain responses, which in turn trigger association with types of content of interest and items of interest.

Based also on the use of Al, anti-counterfeit measures may be provided effectively to detect malicious users who pretend to watch, but actually do not watch the content. This is a significant drawback of prior art systems i.e. lack of reliable viewing confirmation.

The Al may be configured to detect only real persons and to provide confirmation, that a real person/user has seen information/content/advertising. This may be achieved by receiving data from sources of information, such as cameras, microphone and/or any other device, which receives information from the real world about the real person/user. For example, scanning of a users face by a front camera detects whether there is a person present or not, even if the user wears a mask (a face recognition system will detect it). The foregoing makes any attempts to deceive the system nearly impossible (for example due to users gaze changes detection), or sufficiently difficult that is does not make sense to make so much effort to cheat.

The system preferably detects the users/persons gaze during presentation of the content/information/advertising. It may filter minor deviations, such as blinking, short moments of gaze direction change, to arrange smooth viewing confirmation. These filters are optional and can be changed (for example time of distraction from content from microseconds to seconds, turned on or off microphone and so on).

When the system detects, that a user/person has seen the content/adverting/information completely (or above a given duration time threshold, such as percentage of the complete duration) it provides an appropriate confirmation notification. Also the system may comprise an optional part with stopping content/advertising/information playback, if the users/persons gaze was lost i.e. lack of gaze contact has been detected for more than a predefined threshold time for stopping playback.

As mentioned above, viewing confirmation is one of the most important features of the present system. In relation to this aspect, in one embodiment the system may be configured to block users/persons skipping, ignoring or not watching a content item. This feature is based on detecting reactions and in particular eye contact (as described above). When this feature is turned on, the content/information/advertisement is presented only when eye contact has been recognized and otherwise content presentation is paused until eye contact has been detected again.

It is executed to insure, that the user/person will see complete content/advertising/information before continuing using of the device/application, for example a free online cinema, or any other web-site or application, platform, TV portal or the like.

Thus, the present system is a significant improvement detecting whether a user has actually consumed the provided content i.e. watched, listened to or the like.

In an embodiment, the operation of the content presentation system may select content or adapt response analysis based also on specific sources of information present in different environments. For example, in noisy places (public transport, crowded places etc.), the system will recognize it (for example using a microphone and registered noise levels or a geolocation indicating a shopping mall at a time when it is usually very crowded) and will decrease or completely remove audio information from analysis of the persons/users reactions to provide more reliable results.

### FIRST EXAMPLE

The second content item is supposed to be an advertisement of a trip to Paris. The system knows, from the analysis of user consumption of an earlier content item, that the user likes swimming cats, and the main attention is to cats, not to swimming. The second content item may have a common section containing visualization of the Eifel tower. The personalized section for that particular user may be a cat similar to the one that the user liked in the earlier content, walking near the Eifel tower. Therefore, the advertising content will become much more attractive and interesting to the user, applying the users emotional trigger.

### SECOND EXAMPLE

The system knows, from the analysis of user consumption of an earlier content item, that the user likes Paris, and Louvre or Eifel tower trigger a positive response. In this case if the second content item is supposed to be an advertisement of a trip to Paris, that advertisement can be used prepared in advance (because a lot of people have similar reactions to some things, it is reasonable to have a library of such templates at least for the start, when data base for each user is not so big). Moreover, knowing that the user likes Paris, this trigger can be used in advertising of whatever needed by inserting, for example in a beverage advertisement having a common section of people drinking the beverage, a background image of Paris with Louvre or Eifel tower. Moreover, personalized logos or advertising slogans can be generated on demand including the trigger metadata descriptors.

### THIRD EXAMPLE

The system knows, from the analysis of user consumption of an earlier content item, that the user likes cats. If the second content item to be presented is an advertisement of a swimming pool, the system may paste the image of the swimming cat from the first content item into the image of the swimming pool (whereas for another user with different preferences it could be e.g. an image of a swimming dog).

The personalized section can be selected on any device, even not used previously, if it is connected to the system.

The present invention allows for personalized advertising while ensuring that a user actually consumes the presented content. Therefore, the invention provides a useful, concrete and tangible result.

The present system may be implemented as a stand-alone computer system or a distributed computer system as described above. Thus, the machine or transformation test is fulfilled and that the idea is not abstract.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”.

Furthermore, the present invention may take the form of a computer program product embodied in any tangible medium of expression having computer usable program code embodied in the medium.

It can be easily recognized, by one skilled in the art, that the aforementioned method for personalized advertising may be performed and/or controlled by one or more computer programs. Such computer programs are typically executed by utilizing the computing resources in a computing device. Applications are stored on a non-transitory medium. An example of a non-transitory medium is a non-volatile memory, for example a flash memory while an example of a volatile memory is RAM. The computer instructions are executed by a processor. These memories are exemplary recording media for storing computer programs comprising computer-executable instructions performing all the steps of the computer-implemented method according the technical concept presented herein.

While the invention presented herein has been depicted, described, and has been defined with reference to particular preferred embodiments, such references and examples of implementation in the foregoing specification do not imply any limitation on the invention. It will, however, be evident that various modifications and changes may be made thereto without departing from the broader scope of the technical concept. The presented preferred embodiments are exemplary only, and are not exhaustive of the scope of the technical concept presented herein.

Accordingly, the scope of protection is not limited to the preferred embodiments described in the specification, but is only limited by the claims that follow.

1. A method for personalized content presentation to users, the method comprising:
presenting a first content item to a user, wherein the first content item has at least two distinct sections, wherein each of the distinct sections has associated metadata identifying properties of the distinct section;
receiving image data representative of the user watching the first content item while the first content item is being presented;
determining a response of the user to each section of the first content item based on image data representative of the user and storing information on the distinct sections for which the user indicated a positive response as positively-responded sections;
generating a second content item comprising a common section that is common to all of the users and a personalized section, wherein the personalized section is adapted based on the response of the user, such that the personalized section includes content having metadata that is common with metadata of at least one of the positively-responded sections of the user; and
outputting the second content item for presentation to the user.

2. The method according to claim 1, comprising generating the second content item after detecting that the user has consumed the first content item.

3. The method according to claim 1, wherein the personalized section contains at least a part of multimedia data of the positively-responded section.

4. The method according to claim 1, wherein the personalized section contains multimedia data generated by an artificial intelligence module based on metadata of the positively-responded section.

5. The method according to claim 1, further comprising adapting audio or video parameters of at least part of the second content item based on metadata of the positively-responded section, wherein the audio or video parameters include at least one of: video brightness, video contrast, and audio volume.

6. The method according to claim 1 wherein a response of a plurality of the users is detected based on the image data of the users.

7. The method according to claim 6 wherein in case when the response of the plurality of the users is detected, the personalized section is adapted to preferences of the plurality of detected users.

8. The method according to claim 6 wherein in case when the response of the plurality of the users is detected, the personalized section is adapted to preferences of a main user of a device presenting said content to the plurality of the users.

9. The method according to claim 1 wherein selecting the second content item is adapted based on environmental conditions in which the second content item is to be presented.

10. The method according to claim 9 comprising detecting the environmental conditions using a microphone.

11. The method according to claim 9 comprising detecting the environmental conditions using a geolocation.

12. The method according to claim 1 comprising selecting the personalized section from a set of alternative content blocks.

13. A computer program comprising program code means for performing all the steps of the computer-implemented method according to claim 1 when said program is run on a computer.

14. A computer readable medium storing computer-executable instructions performing all the steps of the computer-implemented method according to claim 1 when executed on a computer.

15. A system for personalized content presentation, the system comprising a controller configured to execute the method according to claim 1.
